(19) United States
(12) Patent Application Publication
(10) Pub. No.: US 2014/0037888 A1
(43) Pub. Date: Feb. 6, 2014

(54) PANEL DERIVED THERMOPLASTIC COMPOSITE COMPONENTS AND PRODUCTS

(71) Applicant: SMARTER PLANET LLC, San Francisco, CA (US)

(72) Inventors: Michael Robert O'Reilly, San Francisco, CA (US); Gregory William Pronko, San Francisco, CA (US); David Mayer de Rothschild, Buckinghamshire (GB); Frank P. Becking, Palo Alto, CA (US)

(73) Assignee: SMARTER PLANET LLC, San Francisco, CA (US)

(21) Appl. No.: 13/951,059

(22) Filed: Jul. 25, 2013

Related U.S. Application Data
(63) Continuation of application No. PCT/US2012/023022, filed on Jan. 27, 2012.
(60) Provisional application No. 61/437,492, filed on Jan. 28, 2011.

(51) Int. Cl. B32B 3/06; B63B 35/79; B32B 38/00

(52) U.S. Cl. CPC B32B 3/06; B32B 38/0004; B63B 35/7909
USPC 428/76; 156/256

(57) ABSTRACT

Included herein are constructional techniques for forming thermoplastic composite panels into differently-shaped finished goods. The techniques described are especially useful in forming shaped goods having a complex core.

### CROSS-REFERENCE TO RELATED APPLICATIONS

This application is a continuation of International Application No. PCT/US2012/023022, filed Jan. 27, 2012, which claims priority to U.S. Provisional Application Ser. No. 61/437,492, filed Jan. 28, 2011, both of which are incorporated by reference herein in their entirety for all purposes.

### BACKGROUND

Self-reinforced thermoplastic composites have found utility in a variety of fields. Much of the previous innovation has focused on performance attributes, including the ability to shape, reshape and join the composite pieces. Indeed, numerous patents, such as U.S. Pat. No. 5,954,898 (McKague), teach reforming flat sections (including multiple layers) of bonded/consolidated thermoplastic composite material into differently shaped finished goods. Hence, the re-formability of thermoplastic composite material from a starting blank is well known. U.S. Pat. No. 4,917,747 (Chin) demonstrates connecting panel members by crushing one member into another to form a smooth interface during molding.

Each of US Publication Nos. 2009/0115097 and 2009/0297758 (deGroot) teach various constructional techniques including cutting into a composite panel to interrupt an outer fiber-reinforced “skin” layer (with optional foam removal from a core) and subsequent folding at the interruption to produce corrugated, bent panel and closed-end/edge structures. A supplemental fiber-reinforced layer is set over and bonded at the interrupted section as part of the process.

US Publication Nos. 2009/0110879 and 2009/0107312 (Lewis) also describe techniques for producing folded thermoplastic panel structures. By relieving core material, a foldable section is defined in which the skin on one side of a panel can be reformed over a curved support section machined in the core when the panel is reformed in a bent shape. In so doing, a continuous and (basically) fully supported outer skin is provided along edges/corners of the construction.

Another known approach involves removing section(s) of skin from a honeycomb composite panel. Then the panel is folded until the newly-exposed skin edges meet, allowing the honeycomb in the panel to fold-up like a fan, while supporting the outer radius of the bend. Finally, the interior corner is bonded with a bead of adhesive, employing ultrasonics, solvent or otherwise.

U.S. Pat. Nos. 6,655,434 and 7,951,252 (Danko) describe methods and devices for closing the open end(s) of a composite panel product. These patents illustrate folding-over free ends of panel skin layers to define an edge with a space or gap between the (optionally) overlapped sections of skin and the panel core. U.S. Pat. No. 4,201,609 (Olsen) teaches closing off an edge of a panel by application of heat causing retraction of its core and melting together of inwardly-turning skin sections.

However interesting these approaches, they are limited in scope and applicability to forming fairly simple products. Moreover, many of the products so-produced are structurally deficient as compared to variations of the present inventions as will be apparent to those with skill in the art upon review of the subject filing.

### SUMMARY

The present inventions offer a number of new construction tools suitable for producing high-value thermoplastic (especially, but not limited to, self-reinforced) composite goods incorporated complex-core architectures. These techniques may be paired/utilized in connection with known techniques for handling such material. The present inventions also include the subject products, kits (for production, distribution, sale or otherwise) in which they are included and methods of manufacture and use.

One aspect involves reforming cored thermoplastic composite panels to transform the panel into another useful (non-panel type) structure. Such an approach (i.e., transforming the use of pre-laminated composite panels) offers the potential for tremendous savings in technical labor cost and time as opposed to producing the parts conventionally. To do so, precision removal of core material (e.g., structural foam or honeycomb such as supplied by Hexcel, Inc.) is used to define contoured surface(s) over which to bond reformed panel skin material and close-offer interior or peripheral edges of the structure to be produced.

As stated, the core material is cut-out to define a surface upon which to back and bond overhanging panel skin material (directly or indirectly). Often, the overhanging material will have two free ends (such that the folded-over sections will define an edge when folded-over). However, it is contemplated that one skin facing the core material may remain unaltered.

In addition, it is contemplated that the free end may be modified with puzzle-type features. These may be used to interface with core material pockets when reshaping the skin. Alternatively, they may interfit or interlock with an opposing overhanging skin section as is it formed over the core. Either approach may yield structures more resistant to shear or other damage.

In any case, the process of re-forming is one in which the thermoplastic composite skin is heated to so that it may deform (e.g., with inductive, conductive, radiant and/or convective heat). The process may be done manually, with heated roller(s)/stamper(s), in a mold cavity or otherwise. One advantageous approach employs vacuforming techniques to fold over a first edge in a first mold cavity and then fold over a second edge when transferred to a second mold cavity.

Whatever tooling is used, in addition to deforming the panel skin shape to contact the reformed core, the material is typically heated sufficiently to bond it to the core and/or a new bonding interface (e.g., thermoplastic film) applied to the reshaped core.

Often (though not necessarily) the subject approach of selective core removal and outer composite layer reforming/bonding is used to produce close-ended panel pieces. Exemplary products of this type include various sporting boards (surf, skate, wake, skim, snow, etc.) and subcomponents therefore that include rounded edges or rounded edge sections.

Still, the contours cut into the core material may be shaped otherwise. Likewise, the panel constructions may be interrupted internally. In any case, the edges of the panel are not merely closed flat as in Olsen (above). Neither are they unbacked as in Danko (above). Contrasted in either sense, the core designs provided herein are “complex” in that they exclude the subject matter disclosed in Olsen and Danko.

As an example, a bicycle frame (or a component thereof such as the front triangle for a suspension mountain bike to be connected to an articulable rear linkage) can be produced such that the panel is essentially reformed and reconfigured into a monolithic truss of closed-ended tubes. As in other variations, the core used to define the shape of the folded-over sections can then be removed. Water or chemically soluble foam is suitable for such purpose.

Edge definition around or within a panel section to define products as noted above offers one implementation of the inventions. Another implementation differs dramatically in form factor. Namely, panel sections can instead by reformed to produce various rod-like or handle-like structures.

In one example, each of the head and shaft of a boat oar or kayak/SUP paddle is so-formed. More generally, rods and shafts are produced by undercutting the core by any suitable ratio such that at least a portion of the skin remains attached to the core. A full line or band (of skin to core contact) may remain attached or only one or more spots. Then, the overhanging composite skin is formed over the newly-exposed core shape. In so-forming, the skin is heated to cause matrix material from the thermoplastic composite to bond to the core. Composite fiber orientations and layups are advantageously maintained in this manner to ensure good final construction with no possibility for assembly error (as is a common concern in custom hand-laid composite patterns).

The edges of the skin defining the periphery of the handle may abut one another. Alternatively, they may be trimmed and successively formed so that they overlap and bond to one another. The core may also include relief cut(s) to account for the overlapped material so that the exterior of the handle is smooth. Likewise, this relief-cutting technique can be applied to the other panel constructions described above or otherwise envisioned.

Still another implementation of core-relieving and skin-reforming may be applied to define wing airfoils or wind power turbine blades. Asymmetric cuts in the original form of the composite panel can provide for such a structure. Tapered and/or other complex-shape tubing for bicycle frame or other production may be constructed in this way as well.

The approach also lends itself to variable sizing and customized shape adjustment (e.g., in bicycle tubing) because hard tooling is not necessary for production—thus creating significant cost reduction and ability to build custom configurations without solid mold tooling. Rather, the core can be cut as desired (by altering CNC programming or even sculpted by hand) and then the thermoplastic skin deformed manually or under a membrane press with heat to set the desired shape. As a finishing step or process, the part may then be vacuum-bagged and set in an autoclave to flow the thermoplastic matrix material for bonding and/or surface smoothing.

In another approach, the core material is relieved in simpler fashion. Namely, the core can be cut out from under the panel skin(s) without the inclusion of complex curves. Then, complex shaped inserts (radiused, dual-radiused/semi-circular, tapered, etc.) are added-in to define the shape(s) over which the skin(s) are reformed.

Such an approach is advantageous when working with a honeycomb core in which complex shapes may be difficult to achieve. It also offers advantages for tool access to define the shapes. Although, it is to be recognized that the skin can be formed in a clearance-defining step to orient it out of the way for core shaping after a separation cut is made between the skin and core and then the skin re-formed over the shaped core. Such a clearance procedure can also be useful for pocketing or drilling out the core for installing reinforcement inserts to be bonded to the skin(s) when re-shaped. Examples of such inserts include stainless grommets for marine rope or stays, preformed surfboard fin attachment box(es), wear plates for skateboard nose/tail, etc.

Also, it is to be understood that the skin layers formed over the core material (including inserts to define the shape of the core or as included in the core) can be bonded or shaped directly onto the respective surfaces or have a material layer interposed therebetween. For example, a lower melt adhesive layer may be employed as an intermediate layer. Conversely, a release ply layer (e.g., PTFE material) may be employed when shaping alone is intended in a first step and/or adhesion between overlapping fiber-reinforced skin layers is not intended.

The subject goods are advantageously produced using srPET composite material to facilitate recycling. High melt (a high tenacity/reinforcement fiber component) and lower melt (a matrix material component) portions of the srPET material are advantageously comingled with one another in tows of material woven into fabric. When heated to an appropriate temperature, the low-melt material flows to impregnate the solid-phase high-melt material. Upon cooling (in the case of srPET) a monomeric (and thus easily fully recyclable) composite material results. However, it is to be understood that the teachings herein are not limited to use of srPET, but generally applicable to other thermoplastic composite materials such as produced by Comfil, Inc. and others. Several examples of suitable thermoplastic composite materials offered by the noted vendor are presented in the table below:

| Reinforcement | Matrix | Weight % |
|---|---|---|
| Fibre | Fibre | Reinforcement |
| Glass | LPET | 57 |
| Glass | PET | 57 |
| Glass | PP | 60 |
| | Black | |
| Glass | PP | 60 |
| | Black | |
| Glass | PPS | 63 |
| Carbon | LPET | 54 |
| Carbon | LPET | 54 |
| Carbon | LPET | 54 |
| HTPET | LPET | 50 |
| HTPET | LPET | 50 |
| Aramid | LPET | 48 |

Other suitable materials to form fiber-reinforced layers of composite material utilized in the present inventions are described in any of U.S. Pat. Nos. 3,765,998; 4,414,266; 4238,266; 4,240,857; 5,401,154; 6,828,016; 6,866,738 and US Publication Nos. 2001/0030017 and 2011/0076441 and others. The core material employed may be any compatible expanded foam product, honeycomb as available from Hexcel, Inc., etc.

In addition, it is possible to utilize of composite skins that contain different matrix material (and thus, properties) on each side of a panel to be reconfigured. In one example, very high melt temperature PEEK may be provided as the matrix for the bottom surface of a panel and lower melting PE on the top composite. This type of temp differential allows an oven (or other heating means/approach) to melt the matrix on just one side (while heating the entire part) for a contour bending process while the other side maintains rigidity. Still further, the skins may comprise thermoplastic-backed aluminum or another material, such as thin-film Nitinol, etc.

In all, it is to be understood that the innovation(s) presented herein include a number of thermoplastic construction “tools” suitable for producing high-value self-reinforced composite structural goods (recreational and otherwise). These may be paired/utilized in connection with known techniques for handling such material. The present inventions also include the subject products, kits (for production, distribution, sale or otherwise) in which they are included and methods of manufacture and use. More detailed discussion is presented in connection with the figures below.

### BRIEF DESCRIPTION OF THE FIGURES

The figures provided herein may be diagrammatic and are not necessarily drawn to scale, with some components and features possibly being exaggerated for clarity. Each of the figures diagrammatically illustrates aspects of the inventions. Of these:

FIGS. 1A and 1B are section views illustrating a first complex-core panel construction approach;

FIGS. 2A and 2B illustrate a second such approach in cross-section as well;

FIGS. 3A-3C provide various perspective views of a panel-derived bicycle frame section;

FIGS. 4A and 4B illustrate optional molding techniques and associated tooling elements;

FIG. 5 is a section view illustrating yet another technique for complex core definition;

FIGS. 6A and 6B are side views illustrating a water paddle perform and final construction optionally employing the technique illustrated in FIG. 5;

FIG. 6C is a detailed view of region 6C of FIG. 6B; and

FIG. 7 is a flowchart illustrating processes according to aspects of the present inventions.

Variation of the inventions from the embodiments pictured is, of course, contemplated. Moreover, details commonly understood by those with skill in the art may be omitted from the figures.

### DETAILED DESCRIPTION

As per above, the present inventions include constructional techniques as well as finished goods produced thereby. The techniques can be regarded as new “tools” that can be applied broadly across the composites fields, especially within the self-reinforced composite field. As such, various exemplary embodiments are described below. Reference is made to these examples in a non-limiting sense. They are provided to illustrate more broadly applicable aspects of the present inventions. Various changes may be made to the inventions described and equivalents may be substituted without departing from the true spirit and scope of the inventions. In addition, many modifications may be made to adapt a particular situation, material, composition of matter, process, process act(s) or step(s) to the objective(s), spirit or scope of the present inventions. All such modifications are intended to be within the scope of the claims made herein.

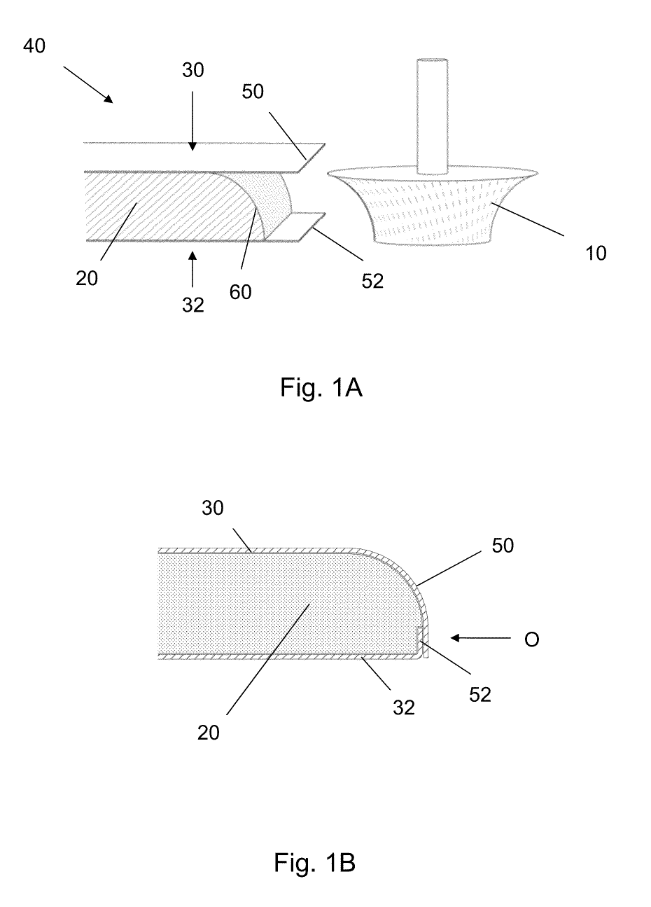

Turning to FIGS. 1A and 1B, a first complex-core panel construction approach in which custom shaped profile tooling 10 (e.g., a bit, saw or blade) is provided to cutout core material 20 from underneath the skins 30, 32 of a sandwich panel 40. The panel is provided laminated together with thermoplastic composite skins bonded to either a honey comb, foam, balsa or another core material. After the core section is shaped (internally profiled), the overhanging ends/tabs 50, 52 of the composite skin can be formed back over the radiused profile 60 of the core shape as further illustrated.

Regarding the core cutting/shaping, it is notable that it can be accomplished with such precision to maintain the integrity of thermoplastic film adhesive layer if included on the interior skin surface(s) during original panel lamination. Alternatively, sections of such material (not shown) may be added along to the overhangs or set upon the cutout profile(s) to assist in adhesion during subsequent forming.

The panel cover skins may comprise fully consolidated (or at least partially consolidated so as to provide dimensional stability) fiber-reinforced thermoplastic composite material. However, the skins may alternatively comprise unalloyed thermoplastic material sheets.

In any case, in FIG. 1B skins 30, 32 are shown re-formed over core 20. They follow the newly-imparted curved shape. At their junction (overlap “O”) it can be seen that the foam core has been undercut or further relieved to allow connection of the skins without producing a discontinuity in closing-off exterior of the construction.

The overlapping section may be bonded when the entire workpiece is set in a heated mold per options further discussed below. Alternatively, the skin sections can be separately heated and shaped (i.e., heat set) as desired, and the overlap separately bonded. Ultrasonics may be advantageously used for subsequent heat bonding of the parts.

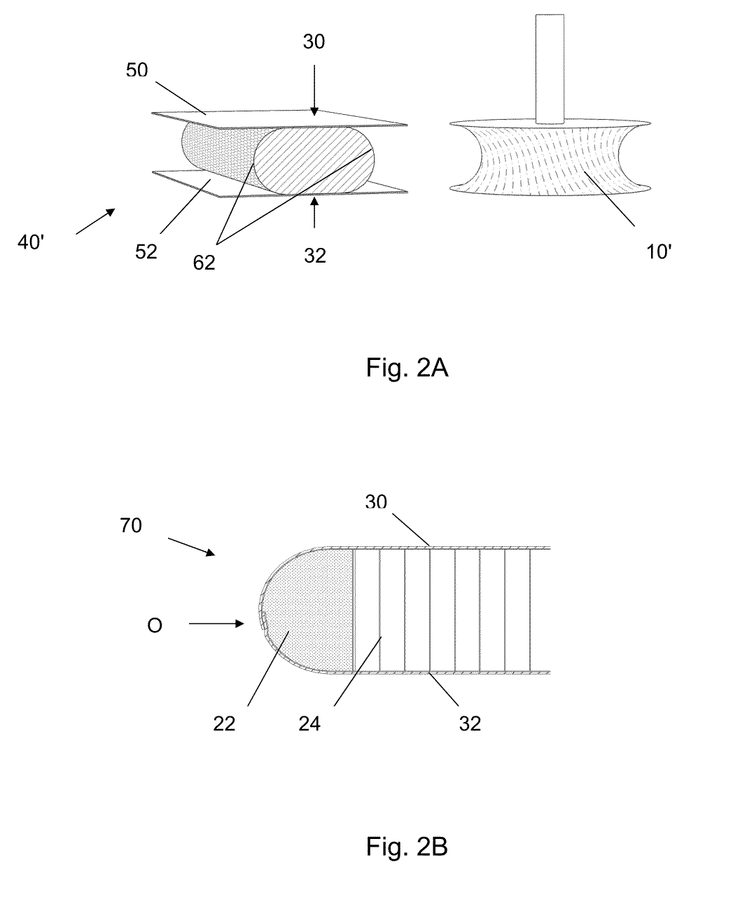

FIG. 2A illustrates core-forming approach with another tool 10′. In this case, both sides of a core are prepared in semi-circular sections 62, together with the skin sections for producing a tubular body or strut. Such a tube may taper from a oblong or oval shape to a cylindrical cross section or it may be constant in cross section along its axis. The closure of the body may be accomplished as shown in FIG. 2B.

Here, the skin layers overlap toward the middle of the curve over which the skins ride. To form a smooth curve, the underlying foam (in this case an insert 22 as further explained) may be relieved as described above. Alternatively, the overlap joint or seam may be compressed into the foam during molding (or separately welding) to provide a substantially smooth outer surface to the finished piece.

FIG. 2B also illustrates the use of a honeycomb core 24 with the panel 70, cut back to a depth to produce ends/tabs as useful for reshaping and closing the subject body. To provide the “complex” aspect of the core, a separately-shaped insert (e.g., foam) 22 is included in the structure as a guide for forming and/or backing the panel skins once reformed. Notably, the insert is shown in cross section only at one level. However, it is to be appreciated that this or other features as described below can be simply tapered (thus varying in dimension along an axis in one direction) or even more complex in shape to vary in shape in two different directions (e.g., as with a curvilinear axis or as with curves that change shape as they run).

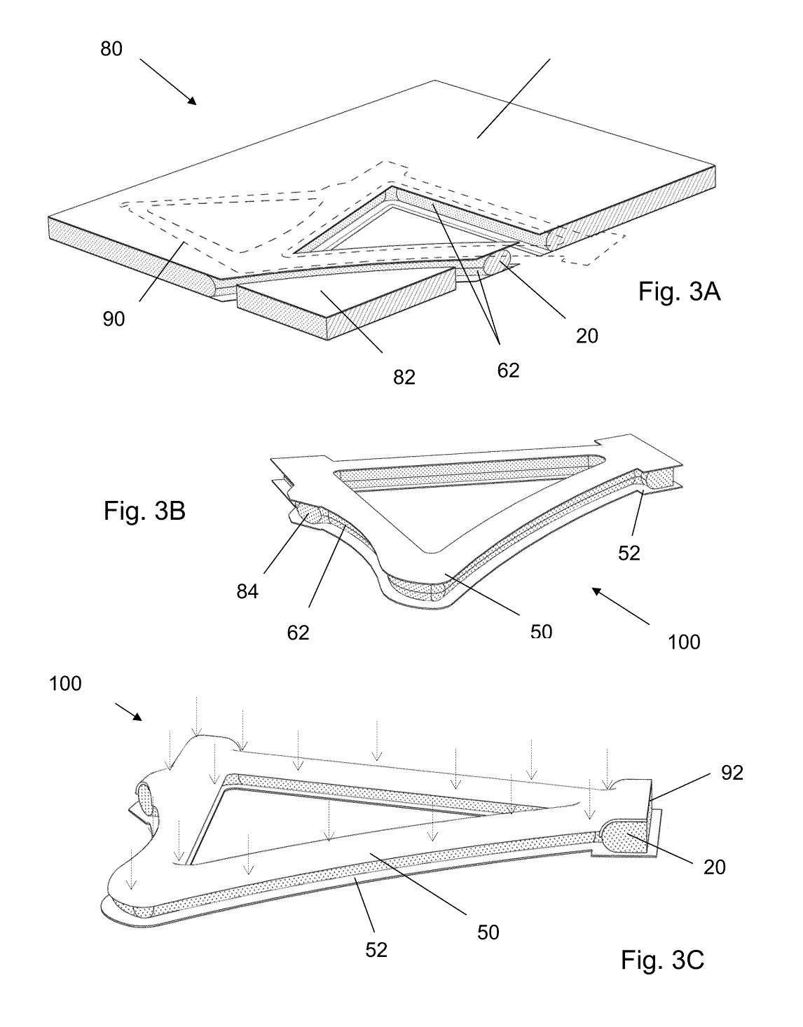

FIGS. 3A-3B provide various perspective views of a panel-derived bicycle frame section. The enclosed truss structure to be formed originates as a panel 80. The panel is optionally custom-produced with fiber orientation, matrix rations and consolidation parameters controlled and optimized. Using CAD software, a pattern for the frame is designed or selected (pattern 90 shown overlaid upon the panel for illustration purposes). Multiple shapes are easily nested onto the panel at one time and cut with CNC milling (or other CAM) machinery. Further, parametric CAD system allow for virtually limitless customizing without the need for shape-specific (other than the indented tube radius) tooling to be formed. Waste sections 82 trimmed off in advance of the profile cutting or otherwise may be recycled, especially when the panel consists of monopolize composite.

An entire frame may be cutout as suggested in FIG. 3A, or the composite work may be limited to the front “triangle” of a frame 100 as shown in FIG. 3B. The front triangle may be married a separately produced rigid rear end, or instead connected to a shock and linkage in producing a full-suspension frame. In any case, various features of the complex shape of the core may be appreciated in reference to FIG. 3B.

Here, a rounded profile 82 fluidly transition along curves and straights defining an open frame. Flat attachment/rework sections 84 of core 20 also remain. These may be processed separately from the initial heat setting/reconfiguration of the skins with more specific tooling or subsequently be removed and replaced with mounting hardware after the composite skins are formed around them.

Regardless, FIG. 3C illustrates the first step in reforming the composite skins. In a heated mold, with a heat gun by hand, or otherwise, the thermoplastic composite skin is shaped onto the profiled core as indicated by the action arrows. Once one side (as in the upper overhang 50) is so-set, the same is done for the obverse.

So-configured, the part may be set in a mold above thermoforming temperature to cause matrix material to actually flow and weld the tubing seams. Pressurized mold elements (such as provided by inflatable bladders, trapped rubber, etc.) along the overlap/seam sections may be useful in this regard. Further processing may include trimming (e.g., as along line 94) and hollowing-out the head tube region to weld in a separate sub assembly, drilling out the bicycle bottom-bracket location, etc. In any case, a body is produced with a closed-off inner periphery.

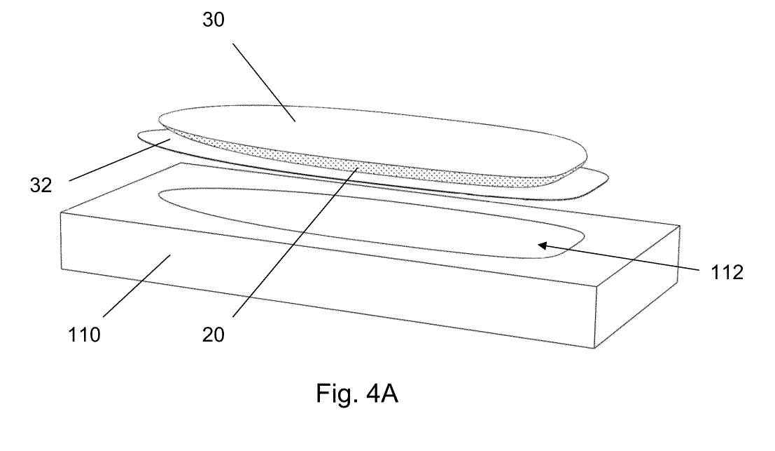

FIGS. 4A and 4B illustrate optional molding techniques and associated tooling elements as may be used as above, or otherwise. In these figures, molding of a water sports board (e.g., a surf, stand-up paddle, skim or wake board) is illustrated.

As to the process, FIG. 4A illustrates placing a construct with its “top” skin 30 formed over the core 20 (as in the bicycle frame component shown in FIG. 3C) in a preceding step. A single heated mold 110 including a cavity 112 may be provided to accomplish this step and/or bonding to the core as well as a subsequent step in which the base/bottom skin layer 32 if formed over the core 20 and/or bonded to the first 30. Otherwise, different staged tools may be used depending on the precision desired and use of subsequent vacuum bagging and heating or other welding procedure(s).

FIG. 4B illustrates another approach. Here, only the lower section of the product core 20 has a composite skin 32 attached. These parts are covered by an upper layer and vacuum is pulled. The top layer may be a removable vacuum bag, or a pre-heated (and thus softened) layer of thermoplastic composite indented to bond and remain with the structure as a top skin 30′.

Further, a mold cover (not shown) or other molding components such as membranes for bagging, release plies, etc. may be provided in connection with either assembly shown in FIG. 4A or 4B. Generally speaking, such ancillary molding tooling and procedures are known in the art.

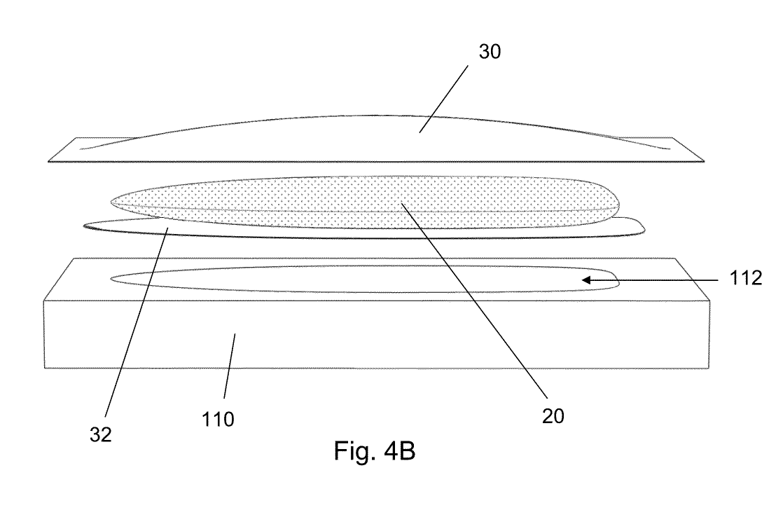

In contrast, the remaining figures illustrate new techniques of manufacture according to other aspects of the present inventions. Specifically, FIG. 5 illustrates an intermediate construct 120 prepared to facilitate extremely complex core shape production.

In order to provide clearance for a CNC mill bit 12 the skin of a panel can be cleared in one or more places. First, a circular saw, heated cutting wire, or other means can be used to separate the overhanging portions 122 of the skin from the core 20. Next, bends 124 may heat set in the skin to hold the overhangs clear of a milling space. Then, milling can commence to profile a surface topography. As shown, the topography changes from a radius profile 60 to a doubly-curved profile 130. After one such section is shaped, a prepared but as-yet unshaped section can then be modified.

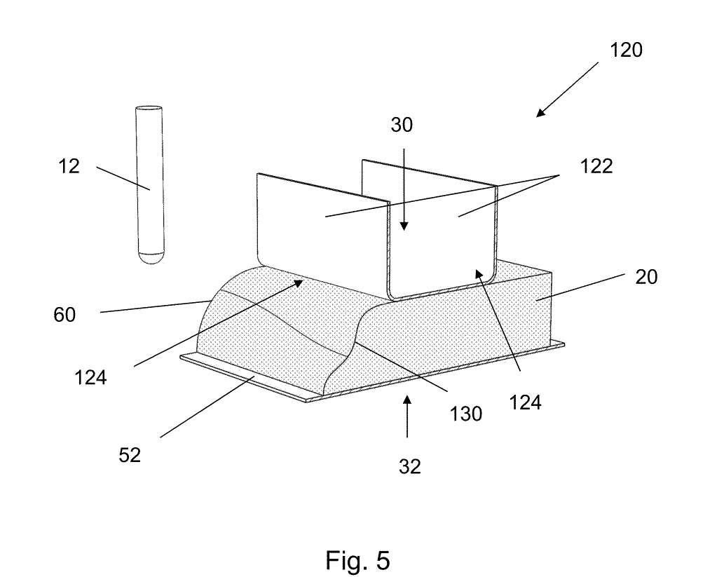

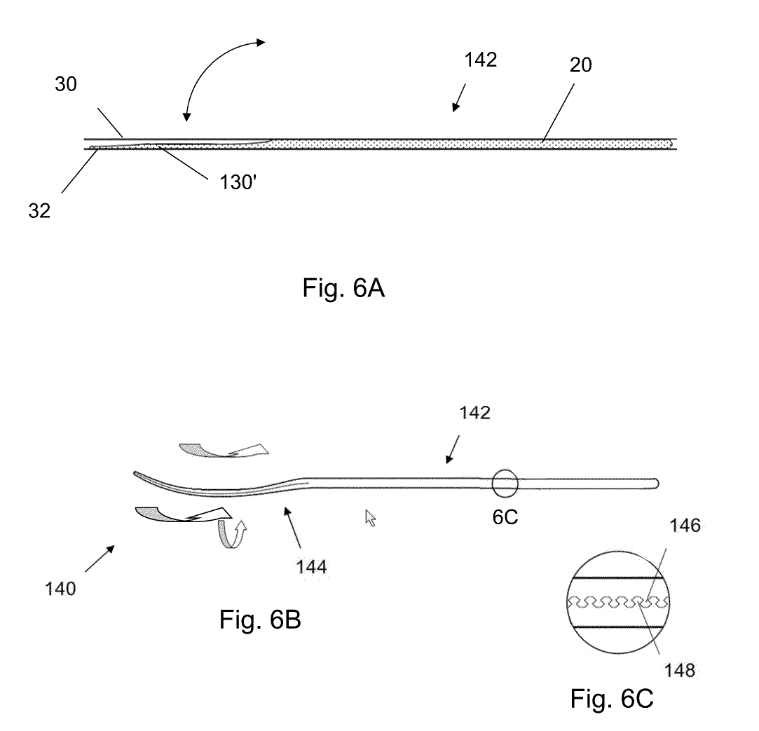

A high performance kayak paddle 140 as represented in FIGS. 6A and 6B can be so-produced. In an intermediate stage of production as shown in FIG. 2A, an elongate shaft 140 is formed with radiused side cuts in core 20.

The handle shaft is finished as shown in FIG. 6B upon wrapping and welding the overhangs along this section. Optionally, the upper and lower skins can be configured such that when they come together they interdigitate and/or lock in puzzle-piece fashion with interlocks 146/148 as illustrated in the included detail view of FIG. 6C. To further strengthen the arrangement, the interface may be overlaid and bonded with a facing layer (not show).

A head 144 of the paddle is shown to be manufactured with a highly variable profile 130′ cut in FIG. 6A. The profile thins out in one direction (distally along the axis of the shaft) and may also change in planform (topview) shape (thus the cross section varies in two different directions). The profiled shape may be achieved using an approach as shown in FIG. 5 by pulling back (and optionally heat setting) the top face of the head of the paddle out of the way as indicated by the action arrow(s) and CNC milling the shape or by other means (including manual sculpting).

In any case, upon heating and molding to close the entire outer periphery of the structure, additional curvature can be imparted upon the shape. The shaping of the head illustrated in FIG. 6B as bowing or dishing around different axes may be accomplished by deforming the skin and core together in the molding procedure. Alternatively, the paddle may be molded relatively flat (i.e., except for the complexity of core taper shown in the head foam) and then reshaped in a post-processing step. Such an approach may simplify initial edge closure and/or seam welding and offer the additional advantage of selection from alternative custom tuning options at the point of sale.

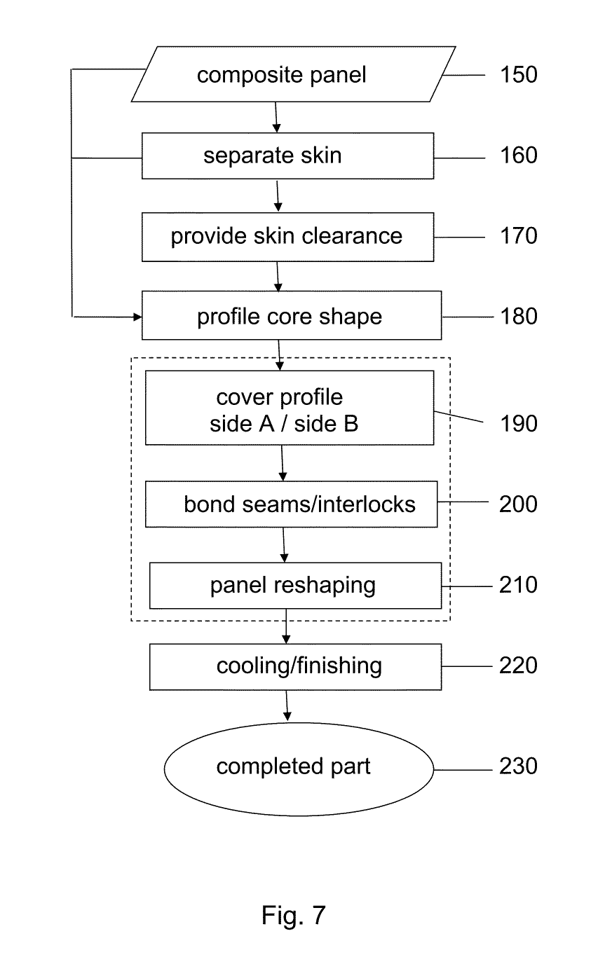

Finally, FIG. 7 is a flowchart presenting various processing options according to the present inventions as conveyed above. After procuring (or producing) a thermoplastic composite panel one or more portions of skin may be separated therefrom at 160 and the skin manipulated (including bending and heat setting out of the way) at 170 to provide clearance for shaping the core at 180. Alternatively, the core may be shaped directly, without the intermediate steps. Then as a single combined act in a mold (as illustrated by the dashed enclosure) or in individual stages, the skin is manipulated to cover the shaped profile at 190, the skin bonded to the core and/or the other skin at 200 and any gross reshaping of the panel 210 accomplished. After cooled (e.g., if heated in a mold vs. locally welded with ultrasonics) and/or finished (such as trimming of flashing, etc.) at 220 a completed part is finally produced at 230.

Variations

It is contemplated that any optional feature of the inventive variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. Likewise, a matter described as “substantially” having some quality includes the possibility that it fully or completely possesses that quality. It is further noted that the claims may be drafted to exclude any optional element. As such, this statement is intended to serve as antecedent basis for use of such exclusive terminology as “solely,” “only,” “alone” and the like in connection with the recitation of claim elements, or use of any type of “negative” claim limitation.

Without the use of such exclusive terminology, the term “comprising” in the claims shall allow for the inclusion of any additional element irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

The breadth of the present inventions are not to be limited to the examples provided and/or the subject specification, but rather only by the scope of the claim language. Use of the term “invention” herein is not intended to limit the scope of the claims in any manner. Rather it should be recognized that the “invention” includes the many variations explicitly and implicitly described herein, including those variations that would be obvious to one of ordinary skill in the art upon reading the present specification. Further, it is not intended that any section or subsection of this specification (i.e., the Summary, Detailed Description, Abstract, Field of the Invention, etc.) be accorded special significance in describing the inventions relative to another or the claims. Any of the teachings presented in one section, may be applied to and/or incorporated in another. The same holds true for the teaching of any of the related applications with respect to any section of the present disclosure. The related applications are:
Low Weight Reinforced Thermoplastic Composite Goods (US provisional application);
Reconfigured Thermoplastic Composite Constructs (US provisional application);
Topo-Slice Thermoplastic Composite Components and Products (PCT application);
Thermoplastic Structures Designed for Welded Assembly (PCT application); and
Hybrid Thermoplastic Composite Goods (PCT application),
   each to the assignee hereof and filed on even date herewith. Moreover, each and every one of these applications is incorporated by reference herein in its entirety for any and all purposes, as are all of the other references cited herein. Should any US published patent application or US patent claim priority to and include the teachings of one or more of the aforementioned US provisional applications, then that US published patent application and that US patent is likewise incorporated by reference herein to the extent it conveys those same teachings. The assignee reserves the right to amend this disclosure to recite those publications or patents by name. Although the foregoing inventions have been described in detail for purposes of clarity of understanding, it is contemplated that certain modifications may be practiced within the scope of the claims made.

1. A composite panel construction produced from a flat panel comprising a core and first and second thermoplastic cover layers bonded to the core, the composite panel construction made by a method of manufacture comprising:
cutting core material from an interior surface of at least one of the cover layers while maintaining a bonded section between the core and the cover layers;
heat setting a portion of the first cover layer in a shape following at least a portion of the cut surface of the core; and
bonding a portion of the second cover layer to a portion of the first cover layer to at least partially close-off the construction.

2. The construction of claim 1, wherein the method of manufacture further comprises cutting the cover layers to yield a net-shape construction upon the heat setting and bonding.

3. The construction of claim 2, wherein the net-shape construction includes no further reinforcement layer where the first and second cover layers are bonded.

4. The construction of claim 1, wherein the heat setting re-bonds the first cover layer portion directly to the core.

5. The construction of claim 1, wherein the heat setting re-bonds the first cover layer portion to the core by an intermediate thermoplastic adhesive layer.

6. The construction of claim 1, where at least one of the skin layers includes a puzzle-piece interface.

7. The construction of claim 1, where the bonding closes off an outer or inner periphery of the construction.

8. The construction of claim 1, wherein the bonding fully closes-off or encapsulates the construction.

9. The construction of claim 1, formed into an elongate body.

10. The construction of claim 9, further comprising a panel section.

11. The construction of claim 1, formed into a truss structure.

12. The construction of claim 1, formed into a curved panel providing at least a portion of a body of a product selected from surf, stand-up paddle, skim and wake boards.

13. The construction of claim 1, wherein a cross section of the core varies along at least one direction.

14. The construction of claim 1, wherein the core surface upon which first cover layer is heat set is curvilinear in shape.

15. The construction of claim 14, wherein the method of manufacture further comprises cutting the core to define its curvilinear surface shape.

16. The construction of claim 14, wherein the method of manufacture further comprises reshaping at least one of the cover layers to provide clearance for cutting the core shape after the core material is cut from its interior.

17. The construction of claim 14, wherein the method of manufacture further comprises adding an insert to the core to define its curvilinear surface shape.

18. A composite panel construction produced from a flat panel comprising a core and first and second thermoplastic cover layers bonded to the core, the composite panel construction made by a method of manufacture comprising:
cutting core material from an interior surface of the cover layers while maintaining a bonded section between the core and the cover layers;
inserting the body into a mold cavity and bonding the first cover layer around the core; and
inserting the body into a same or a different mold cavity and bonding the second cover layer around the first cover layer.

19. The construction of claim 18, wherein the method of manufacture further comprises deforming the panel to define a final shape of the construction.

20. The construction of claim 18, wherein the method of manufacture further comprises shaping at least one of the first and second cover layers prior to insertion of the body into the mold cavity.
